(19) United States
(12) Patent Application Publication
(10) Pub. No.: US 2023/0404155 A1
(43) Pub. Date: Dec. 21, 2023

(54) AEROSOL PROVISION DEVICE HEATING SYSTEM

(71) Applicant: Nicoventures Trading Limited, LONDON (GB)

(72) Inventors: Daniel LOCHTMAN, London (GB); David BUREAU, London (GB); James SHERIDAN, London (GB)

(21) Appl. No.: 18/248,305

(22) PCT Filed: Oct. 12, 2021
(86) PCT No.: PCT/EP2021/078218

§ 371 Date: Apr. 7, 2023

(30) Foreign Application Priority Data
Oct. 16, 2020 (GB) 2016484.4

(51) Int. Cl. A24F 40/465; H05B 6/10; H05B 6/44; H05B 6/06; A24F 40/20; A24F 40/57; A24F 40/51

(52) U.S. Cl. CPC A24F 40/465; H05B 6/105; H05B 6/44; A24F 40/51; A24F 40/20; A24F 40/57; H05B 6/06

(57) ABSTRACT

An aerosol provision device heating system includes a heating region that can receive at least a portion of an article comprising aerosol generating material. The system also includes a first susceptor that extends within the heating region, and a second susceptor that at least partially surrounds at least a portion of the heating region. A first induction coil generates a first varying magnetic field that penetrates, and causes heating in, the first susceptor. A second induction coil generates a second varying magnetic field that penetrates, and causes heating in, the second susceptor. The first and second induction coils may be independently controllable.

### PRIORITY CLAIM

The present application is a National Phase entry of PCT Application No. PCT/EP2021/078218, filed Oct. 12, 2021, which claims priority from GB Application No. 2016484.4, filed Oct. 16, 2020, each of which hereby fully incorporated herein by reference.

### TECHNICAL FIELD

The present disclosure relates to an aerosol provision device heating system, an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol provision device heating system, comprising: a heating region configured to receive at least a portion of an article comprising aerosol generating material; a first susceptor that extends within the heating region, wherein the first susceptor is heatable by penetration with a varying magnetic field; a second susceptor that at least partially surrounds at least a portion of the heating region, wherein the second susceptor is heatable by penetration with a varying magnetic field; a first induction coil configured to generate a first varying magnetic field that penetrates the first susceptor; and a second induction coil configured to generate a second varying magnetic field that penetrates the second susceptor.

The first susceptor may extend within the heating region at an end of the heating region. The first susceptor may protrude into the heating region from an end of the heating region.

The heating region may have a longitudinal axis. The first susceptor may extend within the heating region in the axial direction (i.e. parallel to the longitudinal axis). The first susceptor may extend within the heating region along the longitudinal axis.

The first susceptor may extend within the article. The first susceptor may be configured to extend into the article when the article is received by the heating region.

The first susceptor may comprise a sharp edge or point at a free end.

The first susceptor may extend over a length of: i) ≤40 mm; ii) ≤35 mm; iii) ≤30 mm; iv) s 25 mm; v) ≤20 mm; vi) ≤15 mm; vii) ≤10 mm; or viii) ≤5 mm. The length may be a length in the axial direction.

The second susceptor may comprise a substantially tubular member that surrounds at least a portion of the heating region.

The second susceptor may be configured to extend around at least a portion of the article when the article is received by the heating region.

The first and second susceptors may together extend over a length of: i) >10 mm; ii) >20 mm; iii) >30 mm; iv) >40 mm; v) >50 mm; vi) >60 mm; vii) 70 mm; or viii) >80 mm. The length may be a length in the axial direction.

The heating system may comprise a receptacle defining the heating region. The receptacle may have a base defining the end of the heating region and peripheral wall.

The first susceptor may upstand from the base.

The peripheral wall may comprise a support member and the second susceptor.

The second susceptor may be supported by the support member forming at least part of the peripheral wall.

The support member may comprise a recess extending from an inner surface, and the second susceptor may be in the recess.

The first induction coil may extend around at least a portion of the first susceptor (such that the first varying magnetic field penetrates, and causes heating in, the first susceptor).

The first induction coil may extend around at least a portion of the heating region.

The first induction coil may extend around the longitudinal axis. The first induction coil may extend around a greater axial length of the first susceptor than the second susceptor.

The second induction coil may extend around at least a portion of the second susceptor (such that the second varying magnetic field penetrates, and causes heating in, the second susceptor).

The second induction coil may extend around the longitudinal axis. The second induction coil may extend around a greater axial length of the second susceptor than the first susceptor.

The system may be configured such that the first varying magnetic field causes a greater increase in temperature in the first susceptor than in the second susceptor.

The system may be configured such that the second varying magnetic field causes a greater increase in temperature in the second susceptor than in the first susceptor.

The system may be configured such that the first induction coil transfers greater power to the first susceptor than to the second susceptor.

The system may be configured such that the second induction coil transfers greater power to the second susceptor than to the first susceptor.

The first and second induction coils may be coaxial. The first and second susceptors may be coaxial. The first induction coil and first susceptor may be coaxial. The second induction coil and second susceptor may be coaxial.

A portion of the second susceptor may surround a portion of the first susceptor. That is, some but not all of the axial length of the first susceptor may overlap some but not all of the axial length of the second susceptor in the axial direction.

The second susceptor may comprise one or more discontinuities. The one or more discontinuities may be configured to allow the first varying magnetic field to pass therethrough.

Alternatively, the first and second susceptors may be offset from each other such that the second susceptor does not surround the first susceptor. That is, none of the axial length of the first susceptor may overlap any of the axial length of the second susceptor in the axial direction.

The first susceptor may extend over at least a first distance between the end of the heating region and an (the free) end of the first susceptor. The second susceptor may extend over a second distance between a first end of the second susceptor and a second end of the second susceptor. The first and second susceptors may be offset from each other such that a distance from the end of the heating region to the second end of the second susceptor is greater than the first distance and is greater than the second distance.

The first and second induction coils may be independently controllable.

The system may comprise a control circuit configured to independently control the first and second induction coils.

The system may comprise a first sensor configured to determine a first temperature indicative of a temperature of the first susceptor. The system may comprise a second sensor configured to determine a second temperature indicative of a temperature of the second susceptor. The control circuit may be configured to control the first induction coil based on the first temperature, and to control the second induction coil based on the second temperature.

The system may comprise a first alternating current supply configured to supply a first alternating current to the first induction coil so as to generate the first varying magnetic field. The system may comprise a second alternating current supply configured to supply a second alternating current to the second induction coil so as to generate the second varying magnetic field.

The control circuit may control the first and second alternating currents.

A frequency of the first alternating current may be selected based on one or more properties associated with the first susceptor. A frequency of the second alternating current may be selected based on one or more properties associated with the second susceptor. The one or more properties may be one or more of a susceptor material, shape, size, heating depth, etc.

The frequency of the first alternating current may be selected for efficient heating of the first susceptor. The frequency of the second alternating current may be selected for efficient heating of the second susceptor.

The aerosol generating material may be non-liquid aerosol generating material.

The heating region may be configured to receive at least a portion of an article comprising non-liquid aerosol generating material, and the heating system may be configured to heat the non-liquid aerosol generating material.

The heating system may be configured to heat the first and/or second susceptor to a temperature of between about 200 and about 350° C., such as between about 240° C. and about 300° C., or between about 250° C. and about 280° C.

According to an aspect, there is provided an aerosol provision device comprising the heating system described above.

The aerosol provision device may be a non-combustible aerosol provision device.

The device may be a tobacco heating device, also known as a heat-not-burn device.

According to an aspect, there is provided an aerosol provision system comprising an aerosol provision device described above, and an article comprising aerosol generating material.

The aerosol generating material may be non-liquid aerosol generating material.

The article may be dimensioned to be at least partially received within the heating region.

The article may be dimensioned to be at least partially received within the second susceptor.

The article may be dimensioned to be in contact with the second susceptor when received within the second susceptor. The article may be dimensioned to be pierced at one end by the first susceptor.

According to an aspect, there is provided an aerosol provision device heating system, comprising: a heating region configured to receive at least a portion of an article comprising aerosol generating material; a first susceptor that extends within the heating region, wherein the first susceptor is heatable by penetration with a varying magnetic field; and a second susceptor that at least partially surrounds at least a portion of the heating region, wherein the second susceptor is heatable by penetration with a varying magnetic field.

### BRIEF DESCRIPTION OF THE DRAWINGS

Various embodiments will now be described, by way of example only, and with reference to the accompanying drawings in which:

FIG. 1 shows a front view of an example of an aerosol provision device.

FIG. 2 shows schematically the aerosol provision device of FIG. 1.

FIGS. 3A and 3B show schematically a heater assembly of an aerosol provision device.

FIG. 4A shows a perspective view and FIG. 4B shows a cross-sectional view of an article received in a heater assembly of an aerosol provision device.

FIGS. 5A and 5B show cross-sectional views of an article received in a heater assembly of an aerosol provision device.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

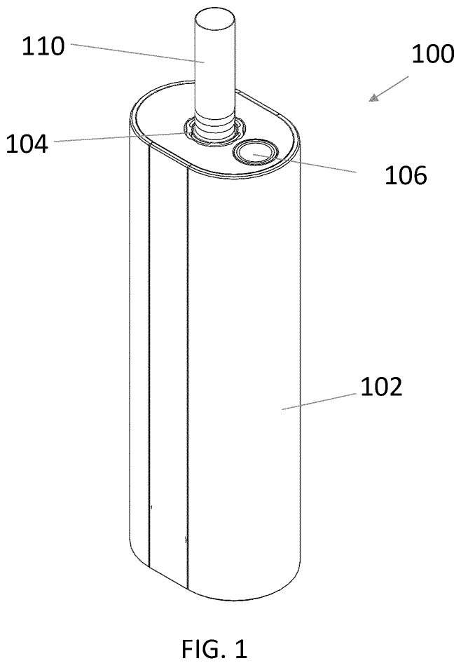

FIG. 1 shows an example of an aerosol provision device 100 for generating aerosol from an aerosol generating medium/material. The device 100 can be used to heat a replaceable article 110 comprising the aerosol generating medium, to generate an aerosol or other inhalable medium which can be inhaled by a user of the device 100.

The device 100 comprises a housing 102 which surrounds and houses various components of the device 100. The device 100 has an opening 104 in one end, through which the article 110 can be inserted for heating by the device 100. The article 110 may be fully or partially inserted into the device 100 for heating by the device 100.

The device 100 may comprise a user-operable control element 106, such as a button or switch, which operates the device 100 when operated, e.g. pressed. For example, a user may activate the device 100 by pressing the switch 106.

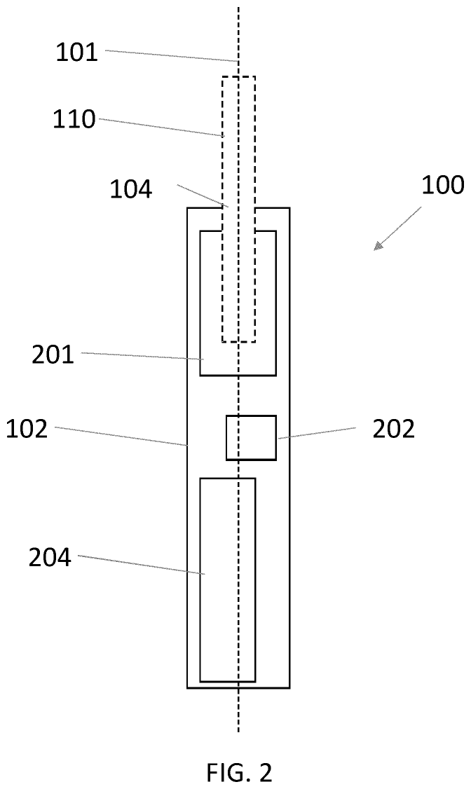

FIG. 2 is a schematic illustration of the aerosol provision device 100 of FIG. 1, showing various components of the device 100. It will be appreciated that the device 100 may include other components not shown in FIG. 2.

As shown in FIG. 2, the device 100 includes a heater assembly 201, a power source 204 and a controller (control circuit) 202. The heater assembly 201 is configured to heat the aerosol generating medium of an article 110 inserted into the device 100, such that an aerosol is generated from the aerosol generating medium. The power source 204 supplies electrical power to the heater assembly 201, and the heater assembly 201 converts the supplied electrical energy into heat energy for heating the aerosol generating medium.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The battery 204 may be electrically coupled to the heater assembly 201 to supply electrical power when required and under control of the controller 202 to heat the aerosol generating material. The control circuit 202 may be configured to activate and deactivate the heater assembly 201 based on a user operating the control element 106. For example, the controller 202 may activate the heater assembly 201 in response to a user operating the switch 106.

The device 100 defines a longitudinal axis 101, along which an article 110 may extend when inserted into the device 100.

The end of the device 100 closest to the opening 104 may be known as the proximal end (or mouth end) of the device 100 because, in use, it is closest to the mouth of the user. In use, a user inserts an article 110 into the opening 104, operates the user control 106 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

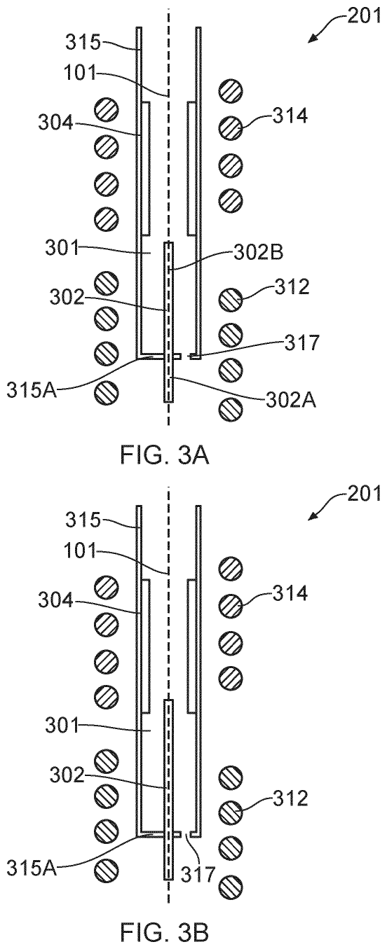

FIGS. 3A and 3B are schematic illustrations of the heater assembly 201 in more detail according to various embodiments. It will be appreciated that the heater assembly 201 may include other components not shown in FIGS. 3A and 3B.

The heater assembly 201 is an inductive heating assembly and comprises various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more induction coils, and a device for passing a varying electric current, such as an alternating electric current, through the induction coil. The varying electric current in the induction coil produces a varying magnetic field. The varying magnetic field penetrates a susceptor (heating element) suitably positioned with respect to the induction coil, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the induction coil and the susceptor, allowing for enhanced freedom in construction and application.

As illustrated in FIG. 3A, the heating assembly 201 includes a heating chamber 301 configured and dimensioned to receive the article 110 to be heated. The heating chamber 301 defines a heating region. In the present example, the article 110 is generally cylindrical, and the heating chamber 301 is correspondingly generally cylindrical in shape. However, other shapes would be possible.

As illustrated in FIG. 3A, the heating chamber 301 may be defined by the inner walls of a support member 315, which may comprise a generally tubular member extending along and around and substantially coaxial with the longitudinal axis 101 of the device 100. The support member 315 (and so heating chamber 301) may be open at its proximal end such that an article 110 inserted into the opening 104 of the device 100 can be received by the heating chamber 301 therethrough. The support member 315 may be closed at its distal end by an end portion 315A. The distal end portion 315A may comprise one or more conduits 317 that form an air passage. In use, the distal end of the article 110 may be positioned in proximity or engagement with the distal end 315A of the heating chamber 301. Air may pass through the one or more conduits 317, into the heating chamber 301, and towards the proximal end of the device 100.

The support member 315 may be formed from an insulating, e.g. non-metallic, material to assist with limiting interference with magnetic induction. For example, the support member 315 may be formed from a plastic, such as polyether ether ketone (PEEK). Other suitable materials are possible. The support member 315 may be formed from such materials ensure that the assembly remains rigid/solid when the susceptor is heated. The support member 315 may be formed from a rigid material to aid support of other components, such as induction coils 312, 314.

Other arrangements for the support member 315 would be possible.

As illustrated in FIG. 3A, the heating assembly 201 comprises a first susceptor 302 and a second susceptor 304. The first and second susceptors 302, 304 are each configured to heat a respective portion of the heating chamber 301. The portion of the heating chamber 301 that the first susceptor 302 heats may overlap or not overlap the portion of the heating chamber 301 that the second susceptor 304 heats.

The first and second susceptors 302, 304 each comprise electrically conducting material suitable for heating by electromagnetic induction. For example, the first and/or second susceptor 302, 304 may be formed from a carbon steel. It will be understood that other suitable materials may be used, for example a ferromagnetic material such as iron, nickel or cobalt. The first and second susceptors 302, 304 may be formed from the same or different materials.

As illustrated in FIG. 3A, the first susceptor 302 may be positioned at the distal end of the heating chamber 301. The first susceptor 302 may extend into the heating chamber 301 from the distal end 315A of the heating chamber 301 along the longitudinal axis 101 of the device (in the axial direction). The first susceptor 302 and heating chamber 301 may thus be coaxial. It would be possible for the first susceptor 302 to extend into the heating chamber 301 e.g. off-axis or not parallel to the axis 101.

As shown in FIG. 3A, the first susceptor 302 may comprise a base portion 302A and a protruding portion 302B. The first susceptor 302 may be supported at the base portion 302A, and the protruding portion 302B may extend into the heating region 301, and, in use, into the article 110A.

The protruding portion 302B of the first susceptor 302 may extend into the heating region 301 by any suitable distance. For example, the protruding portion 302B of the first susceptor 302 may have an axial length within the heating region (that is, the distance between the distal end of the heating chamber 301 and the proximal end of the first susceptor 302) of: (i) 1-5 mm; (ii) 5-10 mm; (iii) 10-15 mm; (iv) 15-20 mm; (v) 20-25 mm; (vi) 25-30 mm; (vii) 30-35 mm; or (viii) 35-40 mm. The axial length of the protruding portion 302B of the first susceptor 302 within the heating region may be: i) ≤40 mm; ii) ≤35 mm; iii) ≤30 mm; iv) ≤25 mm; v) ≤20 mm; vi) ≤15 mm; vii) ≤10 mm; or viii) ≤5 mm.

The heating assembly 201 may be configured such that when an article 110 is received by the heating chamber 301, the protruding portion 302B of the first susceptor 302 extends into a distal end of the article 110. The protruding portion 302B of the first susceptor 302 may thus be positioned, in use, within the article 110. The first susceptor 302 may thus be configured to heat aerosol generating material of an article 110 from within, and for this reason be referred to as an inner susceptor 302. To facilitate this, the first, inner susceptor 302 may be configured to pierce an article 110 that is inserted into the device 100. For example, the protruding portion 302B of the first susceptor 302 may comprise a sharp edge or point at its proximal end. For example, the protruding portion 302B of the first susceptor 302 may be shaped in a pin or blade shape.

As illustrated in FIG. 3A, the second susceptor 304 may be positioned at or towards the proximal end of the heating chamber 301. The second susceptor 304 may be a generally tubular member extending along and substantially coaxial with the longitudinal axis 101. The second susceptor 304 may extend at least partially around an axial portion of the heating chamber 301.

The second susceptor 304 may be supported by the support member 315. The second susceptor 304 and the support member 315 may be coaxial. The first and second susceptors 302, 304 may be coaxial.

The second susceptor 304 may extend continuously around the entire circumference of the heating chamber 301, or only partially extend around the chamber 301. For example, one or more discontinuities, e.g. holes, gaps or slots, may be provided in the second susceptor 304.

The second susceptor 304 may be configured and dimensioned to extend around an article 110 received by the heating chamber 301. The second susceptor 304 may thus be positioned, in use, around an article 110. The second susceptor 304 may thus be configured to heat aerosol generating material of the article 110 from outside, and for this reason be referred to as an outer susceptor 304. The second, outer susceptor 304 may have a circular cross section, e.g. corresponding a circular cross section of the article 110. Other cross sectional shapes would be possible.

The outer susceptor 304 and article 110 may be dimensioned so that, in use, the outer surface of the article 110 abuts the inner surface of the outer susceptor 304. This can help to ensure that the heating is efficient. In this example, the second susceptor 304 protrudes radially inwardly from the support member 315 walls, e.g. such that the article 110 abuts the inner surface of the outer susceptor 304 but is spaced radially from the inner surface of the support member 315. However, other arrangements would be possible. For example, the radial inward surface of the second susceptor 304 could be flush with the support member 315 walls.

The second susceptor 304 may extend along the heating region 301 for any suitable distance. For example, the second susceptor 304 may have an axial length of: (i) 1-5 mm; (ii) 5-10 mm; (iii) 10-15 mm; (iv) 15-20 mm; (v) 20-25 mm; (vi) 25-30 mm; (vii) 30-35 mm; or (viii) 35-40 mm. The axial length of the second susceptor 304 may be less than, the same as, or greater than, the axial length of the protruding portion 302B of the first susceptor 302 within the heating region 301.

Providing both inner 302 and outer 304 susceptors can allow more efficient and effective heating of an article 110, since for example, a lower temperature gradient may be provided across the article 110.

The heating assembly 201 further comprises a first induction coil 312 and a second induction coil 314. The first induction coil 312 extends around at least a portion of the first susceptor 302, and the second induction coil 314 extends around at least a portion of the second susceptor 304. The first induction coil 312 is configured to generate a first varying magnetic field that penetrates the first susceptor 302. The second induction coil 314 is configured to generate a second varying magnetic field that penetrates the second susceptor 304.

The first and second induction coils 312, 314 may each be a helical coil comprising electrically-conductive material, such as copper. Each coil may be formed from wire, such as Litz wire, which is wound helically around the support member 315 and thus the heating chamber 301. Litz wire comprises a plurality of individual wires which are individually insulated and are twisted together to form a single wire. Litz wires are designed to reduce the skin effect losses in a conductor. Other wire types could be used, such as solid.

The first and second induction coils 312, 314 may be substantially the same, or may have at least one characteristic different from each other. For example, the first and second induction coils 312, 314 may have substantially the same or different values of inductance, axial lengths, radii, pitches, numbers of turns, etc. The first and second induction coils 312, 314 may be wound in the same or opposite directions. Winding the coils in opposite directions can help to reduce the current induced by one coil in the other coil.

The first and second induction coils 312, 314 may each extend around, and be supported by, the support member 315. The first and second induction coils 312, 314 may thus each extend around a portion of the heating chamber 301. The first and second induction coils 312, 314 may be arranged coaxially with the support member 315 and heating chamber 301 (and longitudinal axis 101). The first and second induction coils 312, 314 may be arranged coaxially with each other.

The heating assembly 201 may be configured such that the first varying magnetic field generated by the first induction coil 312 causes a greater increase in temperature in the first susceptor 302 than in the second susceptor 304. Similarly, the heating assembly 201 may be configured such that the second varying magnetic field generated by the second induction coil 314 causes a greater increase in temperature in the second susceptor 304 than in the first susceptor 302. The heating assembly 201 may be configured such heating in the first susceptor 302 caused by the second varying magnetic field is minimized or avoided. The heating assembly 201 may be configured such heating in the second susceptor 304 caused by the first varying magnetic field is minimized or avoided. For example, the first varying magnetic field may cause only a negligible increase, or substantially no increase, in temperature in the second susceptor 304, but a non-negligible temperature increase in the first susceptor 302. The second varying magnetic field may cause only a negligible increase, or substantially no increase, in temperature in the first susceptor 302, but a non-negligible temperature increase in the second susceptor 304.

This can be achieved in any suitable manner. For example, as shown in FIG. 3A, the first and second susceptors 302, 304 may be axially offset from each other along the longitudinal axis 101, and the first and second induction coils 312, 314 may be correspondingly axially offset from each other along the longitudinal axis 101, such that a greater axial length of the first susceptor 302 is surrounded by the first induction coil 312 than is surrounded by the second induction coil 314, and such that a greater axial length of the second susceptor 304 is surrounded by the second induction coil 314 than is surrounded by the first induction coil 312.

For example, as illustrated in FIG. 3A, the first induction coil 312 may not extend around the second susceptor 304, and the second induction coil 314 may not extend around the first susceptor 302.

All or only some of the axial length of the first susceptor 302 may be surrounded by the first induction coil 312. All or only some of the axial length of the second susceptor 304 may be surrounded by the second induction coil 314.

As shown in FIG. 3A, the first and second induction coils 312, 314 may be arranged adjacent to each other in a direction along the longitudinal axis 101 of the device 100. That is, the first and second induction coils 312, 314 may not overlap in the axial direction.

As shown in FIG. 3A, the first and second susceptors 302, 304 may be axially offset from each other such that they do not overlap in the axial direction, i.e. such that the second susceptor 304 does not surround the first susceptor 302 (and the first susceptor 302 is not surrounded by the second susceptor 304). In this case, the axial distance between the proximal end of the first susceptor 302 and the distal end of the second susceptor 304 may be less than 10 mm, less than 5 mm, less than 2 mm, less than 1 mm or substantially 0 mm.

FIG. 3B shows an alternative arrangement in which the first and second susceptors 302, 304 overlap in the axial direction. The arrangement of FIG. 3B is otherwise identical to the arrangement of FIG. 3A as discussed herein.

In the example of FIG. 3B, a proximal portion of the first susceptor 302 is surrounded by a distal portion of the second susceptor 304. In other words, some of the protruding portion 302B of the first susceptor 302 is not surrounded by the second susceptor 304, and some of the second susceptor 304 does not surround the first susceptor 302. That is, some but not all of the axial length of the first susceptor 302 overlaps some but not all of the axial length of the second susceptor 304 in the axial direction.

As shown in FIG. 3B, the arrangement may be such that some of the first susceptor 302 is surrounded by the second induction coil 314. It would be possible for some of the second susceptor 304 to be surrounded by the first induction coil 312.

The majority of the axial length of the protruding portion 302B of the first susceptor 302 may not overlap the second susceptor 304 in the axial direction. For example, less than 50%, less than 25%, less than 10%, less than 5% or substantially 0% of the axial length of the protruding portion 302B of the first susceptor 302 within the heating chamber 301 may overlap the second susceptor 304 in the axial direction.

The majority of the axial length of the second susceptor 304 may not overlap the first susceptor 302 in the axial direction. For example, less than 50%, less than 25%, less than 10%, less than 5% or substantially 0% of the axial length of the second susceptor 304 may overlap the first susceptor 302 in the axial direction.

Arranging inner and outer susceptors 302, 304 such that there is only a relatively small or no overlap therebetween can provide a relatively long overall heating region, while allowing the inner susceptor 302 to be kept relatively short, such that the inner susceptor 302 may be able to better withstand forces during insertion and removal of an article 110, for example.

For example, the first and second susceptors 302, 304 together may extend over an axial length that is greater than the axial length of the first susceptor 302 and is greater than the axial length of the second susceptor 304. For example, the first and second susceptors 302, 304 together may extend over an axial length of: i) >10 mm; ii) >20 mm; iii) >30 mm; iv) >40 mm; v) >50 mm; vi) >60 mm; vii) 70 mm; or viii) >80 mm.

In embodiments, some of the first susceptor 302 may be surrounded by the second susceptor 304. The second susceptor 304 in embodiments overlaps at least a portion of the first susceptor 302. At least the portion of the second susceptor 304 that surrounds the first susceptor 302 may comprise one or more discontinuities, e.g. holes, gaps or slots, which are configured to allow the first varying magnetic field to pass therethrough and reach the first susceptor 302 with sufficient strength to cause the desired heating.

Providing at least two induction coils 312, 314 allows independent control over the heating of respective susceptors 302, 304. In various embodiments, therefore, the controller 202 is configured to control the first and second induction coils 312, 314 independently of each other. To do this, the controller 202 may comprise a first control circuit configured to control the first induction coil 312 and a second (independent) control circuit configured to control the second induction coil 314.

For example, the controller 202 may control the first and second induction coils 312, 314 such that the first and second susceptors 302, 304 are heated to the same or different temperatures and/or such that the first and second susceptors 302, 304 are heated according to the same or different temperature-time profiles. For example, the induction coils 312, 314 may be active at different times. For example, initially, the first induction coil 312 may be operating to heat a first section of the article 110, and at a later time, the second induction coil 314 may be operating to heat a second section of the article 110 (or vice versa).

In embodiments, a first alternating current may be supplied to the first induction coil 312 so as to generate the first varying magnetic field. A second alternating current may be supplied to the second induction coil 314 so as to generate the second varying magnetic field. The device 100 may comprise one or more inverters for converting DC current supplied by the battery 204 to alternating current for supplying to the induction coils.

The controller 202 may control the first and second induction coils 312, 314 independently of each other by the first control circuit controlling the first alternating current and the second control circuit controlling the second alternating current. The controller 202 may control the first and second alternating currents to be the same or different.

For example, a frequency of the first alternating current and a frequency of the second alternating current may be the same or different. The frequency of the first alternating current may be selected for efficient heating of the first susceptor 302, for example based on the material, shape, size and desired heating depth of the first susceptor 302. The frequency of the second alternating current may be selected for efficient heating the second susceptor 304, for example based on the material, shape, size and desired heating depth of the second susceptor 304. This may enable particularly efficient heating of different susceptors.

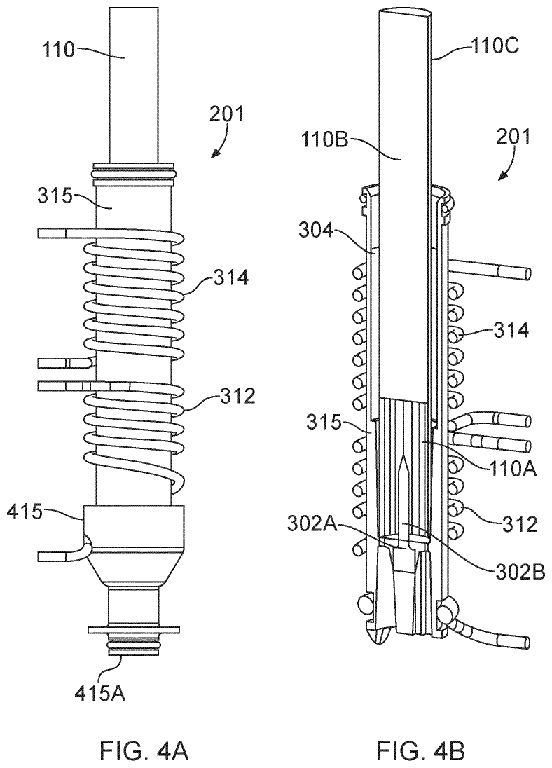

FIG. 4A shows a perspective view and FIG. 4B shows a cross-sectional view of an article 110 received in a heater assembly 201 according to various embodiments. As shown in FIG. 4A, the device 100 may comprise an end support 415 at the distal end of the support member 315. The end support 415 may comprise an air inlet 415A at a distal end. An air passage may pass from the air inlet 415A, through the end support 415 and into the heating chamber 301, for example through conduit 317.

As shown in FIGS. 4A and 4B, in this example the first susceptor 302 is shorter in the axial direction than the second susceptor 304. The axial lengths of the induction coils 312, 314 may correspond to the axial lengths of the respective susceptors 302, 304. Thus, as shown in FIGS. 4A and 4B, in this example the first induction coil 312 has fewer turns, and has a shorter axial length, than the second induction coil 314. In this example, the protruding portion 302B of the first susceptor 302 has a blade shape.

As shown in FIG. 4B, the article 110 may comprise a first distal segment 110A comprising aerosol generating material, and a second proximal segment 110B. The aerosol generating material may be non-liquid aerosol generating material, for example comprising tobacco. The second proximal segment 110B may comprise a filtering and/or cooling structure and/or a mouthpiece. The first and second segments of the article 110 may be wrapped in a wrapper 110C.

As shown in FIG. 4B, in use, the protruding portion 302B of the first susceptor 302 may extend into the first segment 110A of the article 110. The axial lengths of the first segment 110A and the protruding portion 302B of the first susceptor 302 may be such that the protruding portion 302B of the first susceptor 302 does not extend into the second segment 110B of the article 110. Correspondingly, the first induction coil 312 may not surround the second segment 110B of the article 110. Other arrangements would be possible.

As also shown in FIG. 4B, in use, the second susceptor 304 and second induction coil 314 may surround at least some of the first segment 110A of the article 110. The second susceptor 304 and second induction coil 314 may also surround at least some of the second segment 110B of the article 110. However, it would be possible for the second susceptor 304 and second induction coil 314 to not surround the second segment 110B of the article 110.

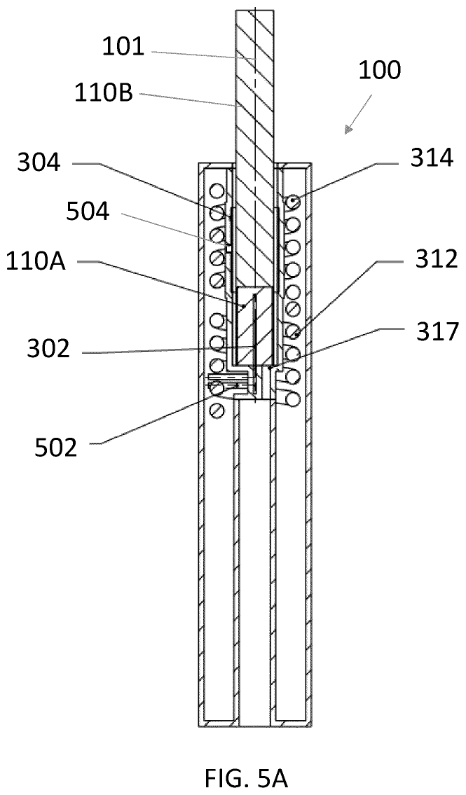

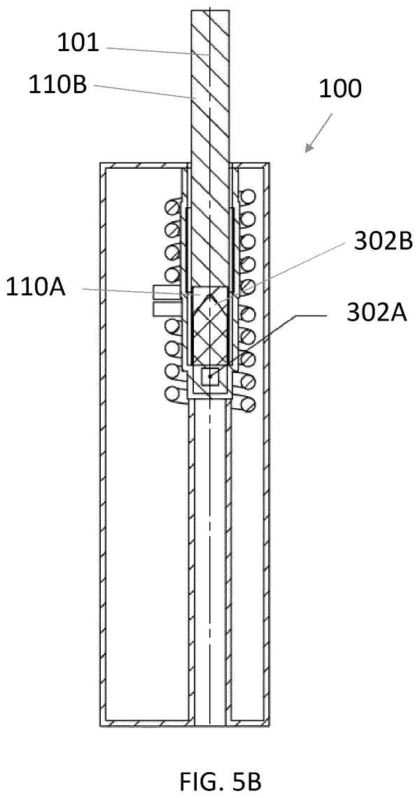

FIGS. 5A and 5B show cross-sectional views of an article 110 received in an aerosol generating device 100 according to various embodiments. FIG. 5A shows a first plane parallel to the longitudinal axis 101, and FIG. 5B shows a second plane parallel to the longitudinal axis 101 that is perpendicular to the first plane.

As shown in FIG. 5A, the device 100 may comprise one or more temperature sensors, such as one or more thermocouples 502, 504. A thermocouple may be configured to determine a temperature indicative of the temperature of the first and/or second susceptors 302, 304. The determined temperature information may be provided to the controller 202, e.g. so as to provide a feedback mechanism for achieving the desired heating.

In embodiments, the device 100 comprises two independent temperature sensors, for example two thermocouples, a first 502 one of which is configured to determine a temperature indicative of the temperature of the first susceptor 302, and a second 504 of which is configured to determine a temperature indicative of the temperature of the second susceptor 304. The determined temperature information may be provided to the controller 202 so as to provide a feedback mechanism for independent control of the first and second induction coils 312, 314. For example, the first control circuit may control the first induction coil 312 based on the temperature information for the first susceptor 302, and the second control circuit may control the second induction coil 314 based on the temperature information for the second susceptor 304.

In embodiments, the first susceptor 302 is fixedly connected to the device 100 such that it extends within the heating region at a fixed position with respect to the second susceptor 304. In these embodiments, the first susceptor 302 may extend into an article 110 when the article 110 is received by the heating region. In other embodiments, however, the first susceptor 302 may be provided within an article 110 that is to be inserted into the device 100. In these embodiments, the first susceptor 302 may be moveable with respect to the second susceptor 304. In these embodiments, the first susceptor 302 may extend within the heating region when the article 110 is received by the heating region.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. An aerosol provision device heating system, comprising:
a heating region configured to receive at least a portion of an article comprising aerosol generating material;
a first susceptor that extends within the heating region, wherein the first susceptor is heatable by penetration with a varying magnetic field;
a second susceptor that at least partially surrounds at least a portion of the heating region, wherein the second susceptor is heatable by penetration with a varying magnetic field;
a first induction coil configured to generate a first varying magnetic field that penetrates the first susceptor; and
a second induction coil configured to generate a second varying magnetic field that penetrates the second susceptor.

2. The aerosol provision device heating system of claim 1, wherein the heating region has a longitudinal axis, and the first susceptor extends within the heating region in an axial direction.

3. The aerosol provision device heating system of claim 1, wherein the first susceptor is configured to extend into the article received by the heating region.

4. The aerosol provision device heating system of claim 1, wherein the first susceptor comprises a sharp edge or a point at a free end.

5. The aerosol provision device heating system of claim 1, wherein the second susceptor is configured to extend around at least a portion of the article received by the heating region.

6. The aerosol provision device heating system of claim 1, wherein the first induction coil extends around at least a portion of the first susceptor.

7. The aerosol provision device heating system of claim 1, wherein the first induction coil extends around at least a portion of the heating region.

8. The aerosol provision device heating system of claim 1, wherein the second induction coil extends around at least a portion of the second susceptor.

9. The aerosol provision device heating system of claim 1, wherein the aerosol provision device heating system is configured such that the first varying magnetic field causes a greater increase in temperature in the first susceptor than in the second susceptor.

10. The aerosol provision device heating system of claim 1, wherein the aerosol provision device heating system is configured such that the second varying magnetic field causes a greater increase in temperature in the second susceptor than in the first susceptor.

11. The aerosol provision device heating system of claim 1, wherein a portion of the second susceptor surrounds a portion of the first susceptor.

12. The aerosol provision device heating system of claim 1, wherein the first susceptor is offset from the second susceptor such that the second susceptor does not surround the first susceptor.

13. The aerosol provision device heating system of claim 1, comprising a control circuit configured to independently control the first induction coil and the second induction coil.

14. The aerosol provision device heating system of claim 13, further comprising a first sensor configured to determine a first temperature indicative of a temperature of the first susceptor, and a second sensor configured to determine a second temperature indicative of a temperature of the second susceptor; wherein the control circuit is configured to control the first induction coil based on the first temperature, and to control the second induction coil based on the second temperature.

15. The aerosol provision device heating system of claim 1, further comprising a first alternating current supply configured to supply a first alternating current to the first induction coil so as to generate the first varying magnetic field, and a second alternating current supply configured to supply a second alternating current to the second induction coil so as to generate the second varying magnetic field.

16. The aerosol provision device heating system of claim 15, wherein a frequency of the first alternating current is selected based on one or more properties associated with the first susceptor, and a frequency of the second alternating current is selected based on one or more properties associated with the second susceptor.

17. The aerosol provision device heating system of claim 1, wherein the heating region is configured to receive at least a portion of an article comprising non-liquid aerosol generating material, and the heating system is configured to heat the non-liquid aerosol generating material.

18. An aerosol provision device comprising the aerosol provision device heating system of claim 1.

19. The aerosol provision device of claim 18, wherein the aerosol provision device is a non-combustible aerosol provision device.

20. An aerosol provision system comprising the aerosol provision device of claim 18, and the article comprising aerosol generating material.
